(19) United States
(12) Patent Application Publication
(10) Pub. No.: US 2011/0173072 A1
(43) Pub. Date: Jul. 14, 2011

(54) SYSTEMS AND METHODS FOR ADVERTISING ON A MOBILE ELECTRONIC DEVICE

(76) Inventors: David Ross, Westport, CT (US); Charles Taylor, Fairfield, CT (US)

(21) Appl. No.: 12/770,459

(22) Filed: Apr. 29, 2010

Related U.S. Application Data
(60) Provisional application No. 61/293,501, filed on Jan. 8, 2010.

(51) Int. Cl. G06Q 30/00

(52) U.S. Cl. 705/14.57; 235/375

(57) ABSTRACT

A system and method for transmitting, accessing, and/or managing promotions transmitted to mobile electronic devices. A user can input preferences for stores and brands that they wish to receive promotions from. Also, a list of stores and brands having promotions can be stored on a promotions system. User location data can be cross-referenced with the user preferences and store and stores carrying brands to determine what, if any, promotions are to be transmitted to a user.

### CROSS-REFERENCE TO RELATED APPLICATIONS

This application claims priority to U.S. Provisional Patent Application No. 61/293,501, filed Jan. 8, 2010, the content of which is incorporated herein by reference in its entirety.

### FIELD OF THE INVENTION

The present invention is generally directed to systems and methods for advertising on a mobile electronic device.

### SUMMARY OF THE INVENTION

In exemplary embodiments, a method for transmitting promotions to a mobile electronic device can comprise providing a promotions system capable of storing, in at least one processor readable memory, (i) a plurality of store location data, (ii) promotions (iii) a plurality of promotions data affiliating a store location with, for example, promotion for the store and a promotion for a brand at the store, (iv) promotions parameters data associated with advertiser preferences for promotions data, (v) user data, and/or (vi) user preferences data including a list of user preferred stores and brands. The method can further comprise receiving, using at least one communications portal, user location data and analyzing, using at least one processor, the user location data and (i) the plurality of store location data, (iii) the a plurality of promotion data, (iv) the promotions parameters data, (v) the user data, and/or (vi) the user preferences data such that a plurality of stores within a predefined distances from a user that are offering promotions and that are user preferred stores and/or stores selling user preferred brands can be identified. Further, the method can include transmitting, using the at least one communication portal, a plurality of promotions to the mobile electronic device for a plurality of stores identified as having promotions that are within a predetermined distance from the user and that are user preferred and/or sell user preferred brands. Also, the method can include receiving redemption information, using the at least one communication portal.

In exemplary embodiments, the redemption information can be stored in the processor readable memory and can be processed by the at least one processor to generate reports. The generated report can further comprise fulfillment data, promotions information, and/or user information.

In exemplary embodiments, the redemption information can further comprise rewards data, stored in the processor readable memory, and/or is processed by the processor that can be used to generate additional rewards.

In exemplary embodiments, the promotions parameter data can be uploaded, via a communication portal, by a campaign manager and/or administrator.

In exemplary embodiments, the transmitted promotions can further comprise a coupon, a discount, a barcode, and/or a free item.

In exemplary embodiments, the generated report can further comprise fulfillment data, user information, ringtone information, quiz information, barcode information, and/or free item information.

In exemplary embodiments, the method can further include transmitting, using at least one communication portal, a promotions program that can be capable of being installed on the mobile electronic device and can be capable of displaying promotions on the mobile electronic device. The promotions can be displayed in a list depicting a store name, the distance the user can be from the store, and/or the number of promotions at the store. A user can select a store having multiple promotions and can view a plurality of promotions depicted in a list view, cover flow view, and/or combination of list view and cover flow view. The promotions program can determine when new promotions can be made available since the user has last viewed the list of promotions and depicts the number of new promotions.

In exemplary embodiments, the promotions can include a coupon, a quiz, and/or an offer to change the alert notification of the mobile electronic device. Further, the generated report can include information about the quantity of use, duration of use, and/or volume during use of the alert notification. In exemplary embodiments, them method can include generating rewards data when the quiz is run on the mobile electronic device and the alert notification of the mobile electronic device can be changed; receiving the rewards data at the promotions system; and transmitting additional promotions based on the rewards data.

In exemplary embodiments, a system for accessing and managing promotions transmitted to a mobile electronic device, can comprise a promotions system. The promotions system can comprise at least one processor readable memory for storing in at least one database (i) a plurality of store location data, (ii) promotions, (iii) a plurality of promotions data affiliating a store location with, for example, a promotion for the store and a promotion for a brand at the store, (iv) promotions parameters data associated with advertiser preferences for promotions data, (v) user data, (vi) user preferences data including a list of user preferred stores and brands, and/or (vii) redemptions data. Further, at least one processor for accessing each of (i) the plurality of store location data, (ii) promotions (iii) the a plurality of promotion data, (iv) the promotions parameters data, (v) the user data, (vi) the user preferences data, and/or (vii) redemption data can be used to generate at least one report. The system can also comprise at least one communication portal for communicating the generated reports based on (i) the plurality of store location data, (ii) the a plurality of promotion data, (iv) the promotions parameters data, (v) the user data, (vi) the user preferences data, and/or (vii) redemption data; and a user can access the promotions system via a web portal and can manage promotions to be transmitted to a mobile electronic device.

In exemplary embodiments, the user can be an administrator and the administrator can access, via the communication portal, the promotions system and can create accounts for users, stored in processor readable memory.

In exemplary embodiments, the reports can be transmitted, via the communications portal, in comma separated variable format to the accessing system.

In exemplary embodiments, the promotions transmitted, via the communications portal, to a mobile electronic device can include discounts, ringtones, and/or quizzes.

In exemplary embodiments, the user can upload, via a communications portal, the quizzes and ringtones to the promotions system and the quizzes and ringtones can be stored in the processor readable memory.

In exemplary embodiments, the generated report can includes information about the quantity of use, duration of use, and/or volume during use of the alert notification.

In exemplary embodiments, the promotion can include a machine readable code.

In exemplary embodiments, the user can generate quizzes on the promotions system by inputting data into predefined field.

In exemplary embodiments, a system for advertising on a mobile electronic device can include a mobile electronic device that can have a communication portal for receiving, for example, transmitted data packets from a promotions generating system. The transmitted data packets can include program data for a promotions program and a promotions data that can include audio data and/or visual data that can be transmitted by a communication portal. The mobile electronic device can include a processor readable memory that can be for storing the received data packets. The mobile electronic device can include a processor that can be for processing the stored data packets such that the mobile electronic device can display the promotion on a graphical user interface and/or can produce an audible sound on a speaker. The processor can also generate a prompt on the graphical user interface of the mobile electronic device, which can be elected or declined. If elected, the promotion can be set as the mobile electronic device's audible alert in exchange for receiving additional promotions.

In exemplary embodiments, when the promotion is elected as the mobile electronic device's audible alert, rewards data can be generated relevant to the duration of use of the audible alert on the mobile electronic device. The rewards data can be transmitted from the communication portal to the promotions system (e.g., promotions generating system) for generating additional promotions for the user based on the rewards data.

In exemplary embodiments, the audible alert can be the mobile electronic device's ringtone.

In exemplary embodiments, the promotion can be an electronic coupon, a video game, a visual commercial, and/or a song associated with a company or product. The advertisement data can be used to convert the promotion into an audible sound.

In exemplary embodiments, the additional promotions can include coupons transmitted by the data transmitter to the mobile phone, money credited to an account for the user, and/or points that can be redeemed for prizes.

In exemplary embodiments, rewards data can include user specific data.

In exemplary embodiments, the data packets can include ringtone data.

In exemplary embodiments, a method for advertising on a mobile electronic device can include transmitting data packets to a mobile electronic device and the transmitted data packets can include program data for a promotions program and a promotion data. The transmitted data packets can include audio data and/or visual data. The transmitted data packets can be for displaying the promotion on, for example, the mobile electronic device and can produce an audible sound on the mobile electronic device. The transmitted data packets can generate a prompt to, for example, elect or decline the promotion as the mobile electronic device's audible alert in exchange for receiving additional promotions. The rewards data can be based on the duration of use of the audible alert on the mobile electronic device. Additional promotions can be generated based on the rewards data and can be transmitted to the mobile electronic device.

In exemplary embodiments, a method for advertising on a mobile electronic device can include receiving data packets on a mobile electronic device from a promotions generating system. The data packets can include program data for a rewards program and a promotions data that can include audio data and/or visual data. The data packets can be for displaying promotions on the mobile electronic device and/or producing an audible sound on the mobile electronic device. The data packets can be for generating a prompt to elect or decline the advertisement as the mobile electronic device's audible alert in exchange for receiving rewards. Rewards data can be produced relevant to the duration of use of the audible alert on the mobile electronic device. The rewards data can be transmitted for generating additional promotions at the promotions generating system based on the rewards data. Additional promotions can be received on the mobile electronic device from the promotions generating system.

In exemplary embodiments, a method of location-based advertising on a mobile electronic device can include at least some of the steps of: receiving a location of the mobile electronic device and determining whether the location of the mobile electronic device is within a predetermined distance from a location of an advertiser stored in a processor readable memory 122, receiving one or more promotions stored in a processor readable memory 122 for the location of the advertiser, providing a notification alert including at least one of an audio and a video notification of the one or more promotions for the location of the advertiser to the mobile electronic device, providing an option to view or decline, for example, the one or more promotions (e.g., advertisements) on the mobile electronic device, sending the one or more promotions (e.g., advertisements) to the mobile electronic device when the option to view the one or more promotions is elected, providing an option to set the notification as the ringtone for the mobile electronic device, and providing a reward for making the notification the ringtone for the mobile electronic device.

In exemplary embodiments, the notification can include at least one of a jingle (e.g., an audible sound that can be related to a product), an audio message, and a video for the advertiser.

In exemplary embodiments, each of the one or more promotions can be valid for at least one selected location of the advertiser and a plurality of locations of the advertiser.

In exemplary embodiments, a method of location-based advertising on a mobile electronic device can include at least some of the steps of: receiving a location of the mobile electronic device and determining whether the location of the mobile electronic device is within a predetermined distance from a location of a retailer stored in a database, receiving an image of a barcode for a product from the mobile electronic device, processing the image to identify the product from the barcode, receiving one or more promotions stored in a database for the location of the retailer for at least one of the product and one or more competing products, and sending the one or more promotions to the mobile electronic device.

In exemplary embodiments, the method can also include determining whether the one or more competing products are, for example, in stock at the location of the retailer.

These and other features of this invention are described in, or are apparent from, the following detailed description of various exemplary embodiments of this invention.

### BRIEF DESCRIPTION OF THE DRAWINGS

The features and advantages of the present invention will be more fully understood with reference to the following, detailed description of an illustrative embodiment of the present invention when taken in conjunction with the accompanying figures, wherein:

FIG. 1A is a block diagram of a mobile electronic device in accordance with the present invention;

FIG. 1B is a block diagram of a promotions generating system in accordance with the present invention;

FIG. 2 is a flow chart of exemplary embodiments of methods of sending promotions and alerts in accordance with the present invention;

FIG. 3 is a flow chart of exemplary embodiments of methods of using proximity information for sending promotions and/or promotion alerts in accordance with the present invention;

FIGS. 4-5 are examples of screen shots from proximity based promotions in accordance with the present invention;

FIGS. 6-7 are flow charts of exemplary embodiments of methods of using games for sending promotions and/or promotion alerts in accordance with the present invention;

FIGS. 8-9 are flow charts of exemplary embodiments of methods of using barcodes in accordance with the present invention;

FIG. 10 is a flow chart of exemplary embodiments of methods of using a locator for locating promotions in accordance with the present invention;

FIG. 11 is a flow chart of exemplary embodiments of methods of receiving promotions and/or promotion alerts in accordance with the present invention;

FIGS. 12-14 are examples of screen shots promotions and/or promotions alerts received in accordance with the present invention;

FIG. 15 is a flow chart of exemplary embodiments of methods of having promotions and/or promotion alerts pushed to a mobile electronic device in accordance with the present invention;

FIG. 16A-B is an example of a screen shots promotions and/or promotions alerts pushed to a mobile electronic device in accordance with the present invention; and

FIGS. 17-18 are flow charts of exemplary embodiments of methods of accessing a promotions generating system in accordance with the present invention.

### DETAILED DESCRIPTION OF THE EXEMPLARY EMBODIMENTS

The term “mobile electronic device” may refer to any portable electronic device that may or may not be enabled with location tracking functionality. For example, a mobile electronic device can include, but is not limited to, a mobile phone, Personal Digital Assistant (PDA), Blackberry®, Pager, Smartphone, or any other reasonable mobile electronic device. For ease, at times the above variations are not listed or are only partially listed, this is in no way meant to be a limitation.

The term “promotion” used herein refers to any advertisement, offer, and/or reward for a product or service. A promotion may inform customers of a product or service, inform customers of the proffers of a product or service, attempt to persuade a customer to purchase a product or service, and provide a discount or incentive to purchase a product or service, such as a coupon. For example, a promotion may include, but is not limited to, at least one of a jingle; an audio and/or video message related to the advertiser, the product, or service that can be the subject of the advertisement, offer, and/or reward; a game; a coupon; a discount on the price of a good; a discount on the price of a purchase; a free item; money, to name a few. For ease, at times the above variations are not listed or are only partially listed, this is in no way meant to be a limitation.

In exemplary embodiments, promotion can be generated and/or transmitted to a user based rewards data. Rewards data can be based on duration of use of a changed audible alert, user information, user location, location information, user preferences, user favorites, usage of a game, and product information, to name a few. For example, rewards data can be based on, but is not limited to, at least one of the amount of time the changed audible alert was set as the primary audible alert for the device, the length of time of the audible alert, the number of times the audible alert was played, or any other reasonable measure of duration of use.

A promotion alert can include any form of alert (e.g., notification) on a mobile electronic device of the existence of an advertisement. For example, a promotion alert may include, but is not limited to, a jingle, an audio and/or video message, an audio and/or video message related to the advertiser, the product or service that can be the subject of the offer, or any other reasonable form of alert. Further, a promotion alert can be transmitted with an/or include a promotion. For ease, at times the above variations are not listed or are only partially listed, this is in no way meant to be a limitation.

The terms “locating,” “location data,” “location information,” and “location tracking” as used herein may refer to any form of location tracking technology or locating method that can be used to provide a location of a mobile electronic device, such as, but not limited to, at least one of location information manually input by a user, such as, but not limited to entering the city, town, municipality, zip code, area code, cross streets, or by any other reasonable entry to determine a geographical area; Global Positions Systems (GPS); GPS accessed using Bluetooth®; GPS accessed using any reasonable form of wireless and/or non-wireless communication; WiFi™ server location data; Bluetooth® based location data; triangulation such as, but not limited to, network based triangulation, WiFi™ server information based triangulation, Bluetooth® server information based triangulation; Cell Identification based triangulation, Enhanced Cell Identification based triangulation, Uplink-Time difference of arrival (U-TDOA) based triangulation, Time of arrival (TOA) based triangulation, Angle of arrival (AOA) based triangulation; techniques and systems using a geographic coordinate system such as, but not limited to, longitudinal and latitudinal based, geodesic height based, cartesian coordinates based; Radio Frequency Identification such as, but not limited to, Long range RFID, Short range RFID; using any form of RFID tag such as, but not limited to active RFID tags, passive RFID tags, battery assisted passive RFID tags; or any other reasonable way to determine location. For ease, at times the above variations are not listed or are only partially listed, this is in no way meant to be a limitation.

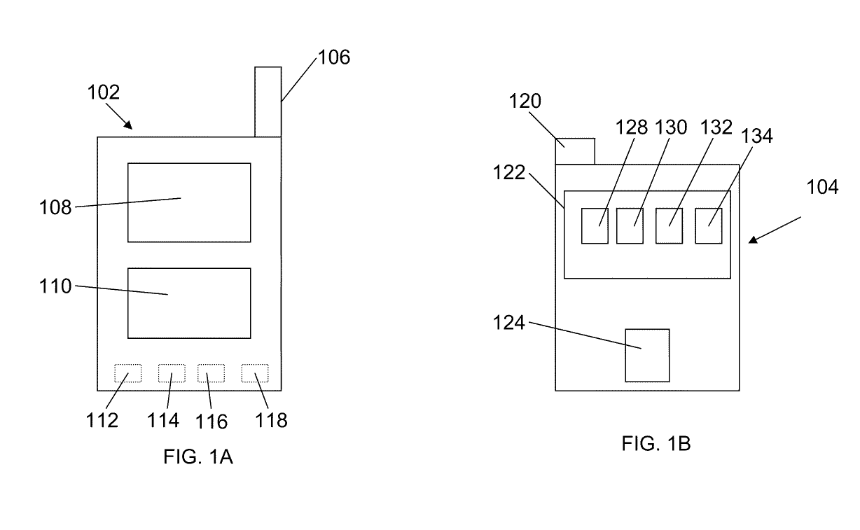

Referring to FIG. 1, in exemplary embodiments, a mobile electronic device 102 and a promotions generating system 104 can be wirelessly connected for use in transmitting promotion alerts and generated promotion alerts, promotions, and/or rewards data on mobile electronic device 102. For example, generated promotion alerts can be, but is not limited to promotion alerts that are played, used, displayed, transmitted in part or in full, and populated in a field in part or in full, to name a few.

Mobile electronic device 102 and promotions generating system 104 can wirelessly communicate using standard data transmission techniques. For example, data packets can be transmitted that can include, but are not limited to, program data for a promotions program, rewards data, and promotions. Any of which can include at least one of audio data and visual data, and data to populate a field. For example, a field can be populated in an individual promotion page, an promotion list and a main/home page, to name a few. As shown, mobile electronic device 102 can include, but is not limited to, a communication portal 106, a graphical user interface 108, a user input 110, a speaker 112, a processor readable memory 114, and a processor 116, and any other reasonable components for use in a mobile electronic device. In some instances, graphical user interface 108 and user input 110 can be substantially the same. For example, graphical user interface 108 and user input 110 can be combined as a touch screen. Further, in some instances mobile electronic device 102 can include a location tracking device 118, such as a global positioning, WiFi, or RFID transmitter/receiver.

Promotions generating system 104 can include, but is not limited to, a communication portal 120, a processor readable memory 122, a processor 124, and any other reasonable component for use in a transmitting/receiving data packets, storing data and processing any form of information. Information can include any form of information such as, but not limited to data. In some instances, processor readable memory 122 can include, but is not limited to, a rewards data database 128, promotions database 130, location database 132, user/device database 134, or any other reasonable database. Further, promotions generating system 104 can be at one location and/or can include external elements capable of communicating with each other, for example, via a network and/or the internet.

Promotions generating system 104 can communicate with at least one additional electronic system (not shown). For example, an additional electronic system can include, but is not limited to a communication portal, a processor readable memory, and a processor. As described below, a user can access, directly and/or indirectly, promotions generating system 104 via mobile electronic device 102 and/or an at least one additional electronic system. For example, a user can access promotion generating system 104 using mobile electronic device 102 and/or at least one additional electronic system via a user interface, such as, but not limited to a website, dashboard, and/or any other reasonable access technique.

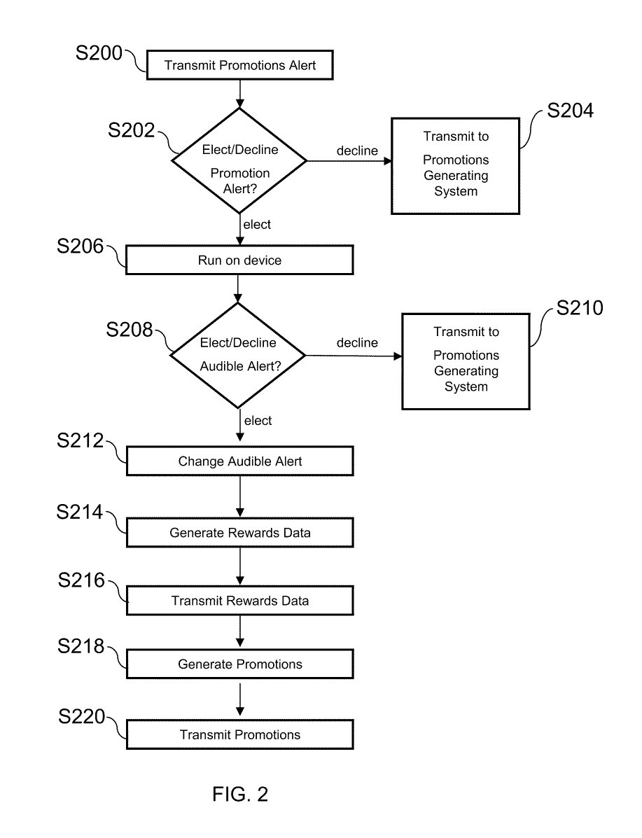

Referring to FIG. 2, in exemplary embodiments, promotion alerts and/or promotions can be transmitted to mobile electronic device 102 and rewards data can be generated based on accepting to change the audible alert played on speaker 106 of mobile electronic device 102 to a predetermined audible alert. It will be understood that an audible alert can include, but is not limited to a ring tone, vibration alert, email alert, and message alert, to name a few. Rewards data can be generated based on the duration of use of the changed audible alert, the number of times the changed audible alert is played, or any other reasonable measure of duration of use.

For example, at step 200, a promotion alert can be transmitted to mobile electronic device 102 from promotions generating system 104 to notify the user of the existence of an advertisement. The promotion alert can, but is not limited to, activate the mobile electronic device's user alert, generate an audio or video advertisement played on the mobile electronic device, such as a jingle, an audio message, or a video specific to the advertiser, the product that can be the subject of the offer, or the service that can be the subject of the offer. At step 202, the user can elect or decline the promotion alert by, for example, interacting with at least one of graphical user interface 108 and user input 110. If not elected, information can be transmitted from mobile electronic device 102 to promotions generating system 104, at step 204, to compile a list of non-elected promotion alerts sent to mobile electronic device 102 that can be stored in user/device database 134. If a promotion is elected, at least one of a jingle, an audio and/or video message, a game, or any other reasonable transmission related to the advertiser, a product, or service capable of being played on mobile electronic device 102 can be stored in processor readable memory 114, and can be generated, by processor 116, on at least one of graphical user interface 108 and speaker 112 of mobile electronic device 102, at step 206.

A step 208, a user can elect or decline to have the audible alert on mobile electronic device changed to a predetermined audible alert relating to, for example, a company, product, or target market in exchange for rewards data. If not elected, information can be transmitted from mobile electronic device 102 to promotions generating system 104, at step 210. If elected, the audible alert on mobile electronic device 102 can be changed to a predetermined audible alert that can be played on, for example, speaker 112, at step 212. At step 214, rewards data can be generated based on at least one of the usage of the a jingle, an audio and/or video message, a game, etc. and/or accepting to change the audible alert on mobile electronic device 102 to a predetermined audible alert.

At step 216, rewards data can be transmitted to promotions generating system 104 including a rewards database 128. At step 218, promotions can be generated based on at least one of the rewards data and data in the processor readable memory 122. At step 220, promotions can be transmitted to mobile electronic device 102 from promotions generating system 104.

In some instances, a user may not be required to, or may skip, the option to elect or decline at least one of the promotion alert, at step 202, or predetermined audible alert, at step 208. For example, the user can have set preferences to receive all promotions of audible alerts from some advertisers.

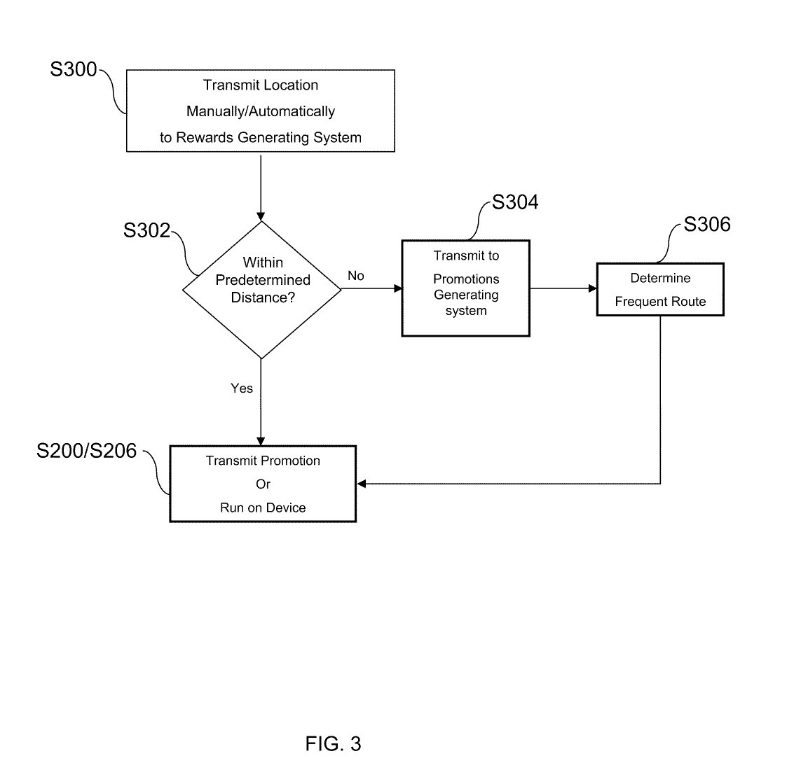

Referring to FIG. 3, in exemplary embodiments, promotion alerts and/or promotions can be transmitted to mobile electronic device 102 from promotions generating system 104 based on the location of mobile electronic device 102. For example, at step 300, mobile electronic device 102 can transmit location data (e.g., automatically transmit, transmit based on a manual user input, etc.) to promotions generating system 104 in communication with a processor readable memory 122. Location data can be based on, but is not limited to, at least one of location information manually input by a user, such as, but not limited to entering the city, town, municipality, zip code, area code, cross streets, or by any other reasonable entry to determine a geographical area or automatically input by, for example, Global Positions Systems (GPS), network based triangulation, WiFi™ server information, Cell Identification, Enhanced Cell Identification, Uplink-Time difference of arrival (U-TDOA), Time of arrival (TOA), Angle of arrival (AOA), or any other reasonable way to determine location data.

At step 302, the location of device 102 can be cross-referenced with data stored in database 122. For example, based on logic based commands, promotions generating system 102 can determine when an advertiser offering a promotion is within a predetermined distance of mobile electronic device 102 (e.g., a 100 yard radius, a quarter mile radius, a 1 mile radius, etc. or within a zip code, city, state, etc.). Promotions generating system 102 can determine available promotions by, for example, having processor 124 compare (e.g., calculate) the location of mobile electronic device 102 to data compiled from at least one of, but not limited to, data relating to promotions using promotions database 128, data relating to applicable advertisers using data in advertiser database 230, data relating to location information of various applicable advertisers using data in location database 132, and data relating to the user/device information using data in user/device database 134, to name a few.

In exemplary embodiments, if a promotion is within a predetermined distance of mobile electronic device 102, then promotion alerts and/or promotions can be transmitted to mobile electronic device 102 from promotions generating system 104, by for example, following step 200 displayed and detailed above in reference to FIG. 2. If a promotion is not within a predetermined distance of mobile electronic device 102, location data relevant to mobile electronic device 102 may be stored in processor readable memory 122, at step 304 for determining user location trends. For example, location data may be stored for determining routes (e.g., frequent routes) taken by the user at particular times of the day, at step 306. If a frequent route is determined, promotions generating system 104 can generate a promotion alert and/or promotion based on promotions located along the user's route or near the ultimate destination of the user and transmit the promotion alert and/or promotion to mobile electronic device 102 from promotions generating system 104 by, for example, following step 200 displayed and detailed above in reference to FIG. 2.

In exemplary embodiments, if a promotion is within a predetermined distance of mobile electronic device 102 then a promotion alert indicating at least one promotion is available can be transmitted to mobile electronic device 102 from promotions generating system 104 by, for example, following step 206 displayed and detailed above in reference to FIG. 2. In some instances, at least one promotion can be sent to mobile electronic device 102 based on location data without sending a promotion alert.

In exemplary embodiments, if promotion alerts and/or promotions are transmitted to mobile electronic device 102 from promotions generating system 104 based on the stored location data of mobile electronic device 102, rewards data can also be generated. Similarly described above, rewards data can be generated based on the duration of use of the changed audible alert.

In exemplary embodiments, a user of mobile electronic device 102 may set the promotions generating system to search for nearby locations of a particular advertiser. By way of example, while traveling in a car, a user could enter a particular advertiser and a predetermined distance (e.g., one quarter mile from Burger King®), and promotions generating system 104 can provide promotion alerts and/or promotions for any locations of advertisers that come within the predetermined distance of mobile electronic device 102. When an advertiser comes within the predetermine distance, the promotions generating system 104 can generate promotion alerts and/or promotions in the form of an audio and/or video notification, such as a audio jingle (e.g., a corporate jingle related to Burger King®), that alerts the user to the offer. Thus, the user, and those surrounding the user, will hear the audio notification and/or view the video notification any time the user's mobile electronic device comes within the predetermined distance of the advertiser.

In exemplary embodiments, the speed at which the user is traveling can factor into the determination of the length of the predetermined distance to receive promotion alerts and/or promotions. For example, if the user is driving 60 miles an hour, the distance for receiving promotion alerts and/or promotions can be further than if the user is walking at 4 miles an hour.

In exemplary embodiments, a user may also manually search the promotions generating system 102 for all locations of particular advertisers, a particular stores and/or brands, or type of advertisers within a specified distance from the mobile electronic device (e.g., one quarter mile from the location of the mobile electronic device) or within a specified location (e.g., a particular zip code, city, state, etc.). When promotion alerts and/or promotions are available within the specified distance or location, the promotions generating system 104 may generate promotion alerts and/or promotions.

In exemplary embodiments, loyalty promotions can be offered each time promotion alerts and/or promotions are played on mobile electronic device 102. Loyalty promotions can also be offered as incentive to users who keep the audio or video notification on their mobile electronic device and use the audio or video notification as their main ringtone for answering incoming phone calls on an ongoing basis. For example, the incentive can be active and not require the user to manually search for promotions.

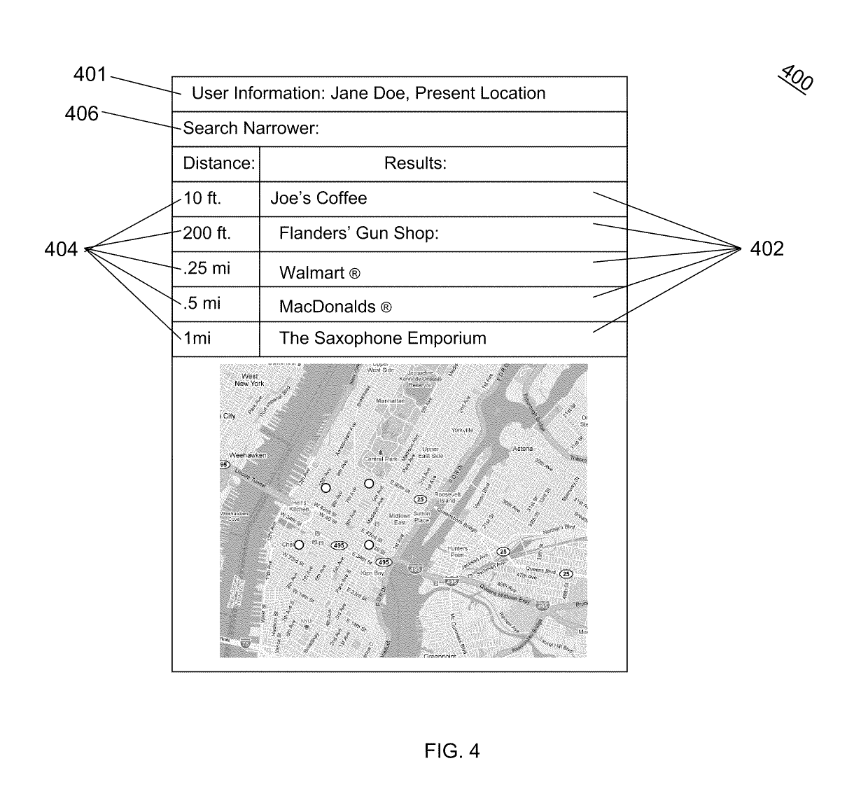

Referring to FIG. 4, in exemplary embodiments, promotion alerts and/or promotions can be displayed in a main/home page 400 that can be displayed on mobile electronic device 102. In exemplary embodiments, using the methods describe above, promotion alerts and/or promotions available with a predetermined distance of mobile electronic device 102 can be displayed by populating a list of advertisers 402 in main/home page 400. For example, as shown, main/home page 400 can include, but is not limited to, user information 401, a list of advertisers 402, and a list of distances from the user's present location to the advertiser 404. Data for the main/home page 400 can be at least one of transmitted to, stored on, or partially stored on and partially transmitted to the mobile electronic device 102. For example, promotions generating system 104 may only transmit data to mobile electronic device 102 for populating fields in the main/home page. In some instances, main/home page 400 can include a visual depiction (e.g., a map) of the location of each of the advertisers displayed in the list of the advertisers 402.

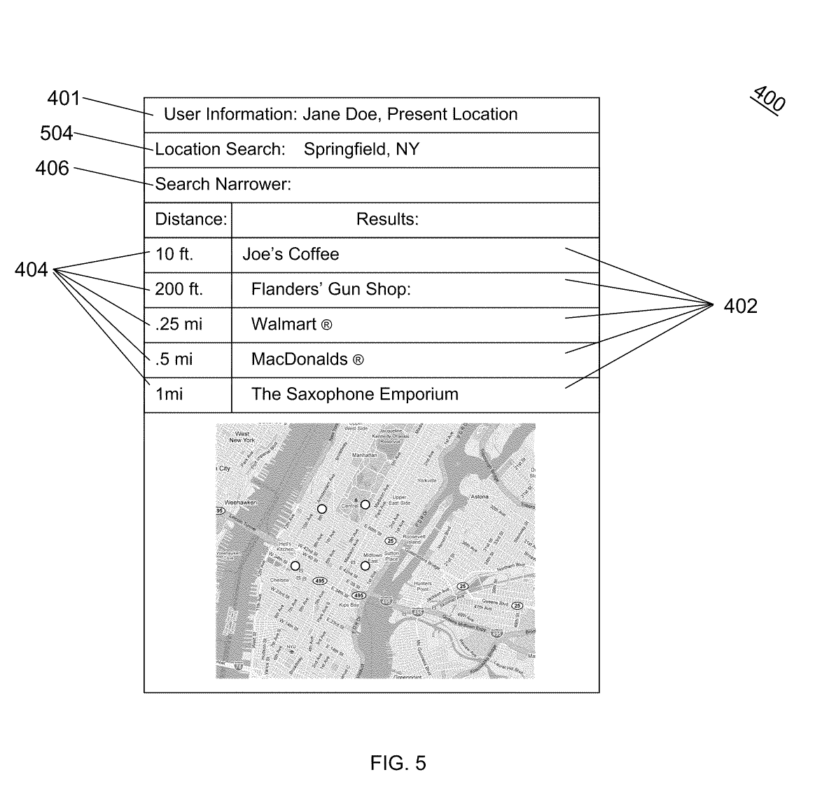

Referring to FIG. 5, in exemplary embodiments, using the methods describe above, promotions can be displayed in list of advertisers 402 in main/home page 400 based on a location search manually entered by a user. For example, a user can manually enter location information in location search field 500. This may be done to allow a user to find a store having promotions based on the user's input location. For example, as shown, main/home page 400 can include, but is not limited to, user information 401, a list of advertisers 402, and a list of distances 404, and a location search field 500 which can be manual entered in by a user.

In exemplary embodiments, the user can select to view any number of the promotions for any number of advertisers (e.g., displayed in the list of advertisers 402). In response to a user's selection, promotions generating system 104 can transmit at least one promotion to be played on the device, such as a jingle, an audio and/or video message, or a game to mobile electronic device 102.

In exemplary embodiments, the results (e.g., list of advertisers 404 and distance 404) displayed on main/home page 400 can be narrowed by entering information in a search narrower field 406. For example, a user may narrow the list of advertisers by changing the distance for results to a shorter distance (e.g., change the predetermined distance from 5 miles to 1 mile). In exemplary embodiments, after having the search narrowed, the user can select to view any number of the promotions for any number of advertisers. In response to a user's selection, promotions generating system 104 can send at least one promotion to mobile electronic device 102 any of which may be specific to the advertiser's product or service.

In exemplary embodiments, at least one promotion transmitted to mobile electronic device 102 from promotions generating system 104, using any of the techniques described herein, can be used to generate rewards data. For example, similarly described above, rewards data can be generated by accepting to change the audible alert of the mobile electronic device to a predetermined audible alert and rewards data can be generated based on the duration of use of the changed audible alert.

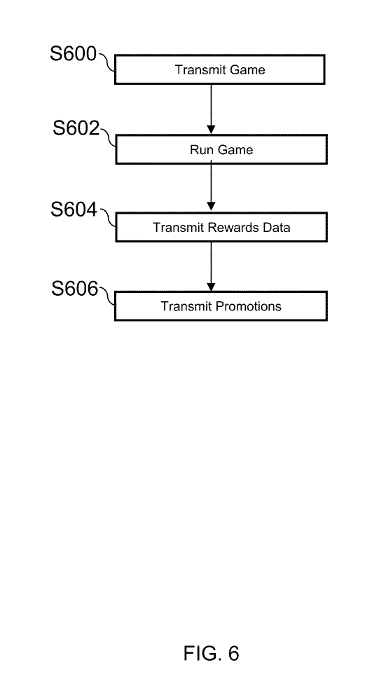

Referring to FIG. 6, in exemplary embodiments, at least one game can be transmitted to mobile electronic device 102 and rewards data and/or a promotion can be generated based on, for example, usage of the game. For example, at step 600 a game can be transmitted to mobile electronic device 102. The game can be stored in processor readable memory 114, processed by processor 116, and the user can view the game on graphical user interface 108. At step 602, the user can play the game by for example interacting with the game displayed on graphical user interface 108. At any point before playing the game, after playing the game, or during the game, the user can receive an option to obtain promotions in exchange for changing the audible alert on mobile electronic device 102. Similarly described above, rewards data can be generated by accepting to change the audible alert of the mobile electronic device to a predetermined audible alert and rewards data can be generated based on the duration of use of the changed audible alert. In some instances, rewards data can be based on the duration of time the user played the game, the length of the game, the difficulty of the game, the user's score in the game, and/or any other reasonable method of obtaining promotions for playing a game. Further, a user can receive a premium prize (e.g., more promotions, a coupon, a coupon in the form of a barcode, described below, etc.) if they are able to beat the game or obtain a predetermined score. The game can include, but is not limited to, a core game, a casual game, a serious game, trivia, a puzzle, or any other reasonable form of game.

At step 604, rewards data can be transmitted to promotions generating system 104 from mobile electronic device 102. Based on rewards data, at step 606, promotions can be generated and transmitted from promotions generating system 104 to mobile electronic device 102.

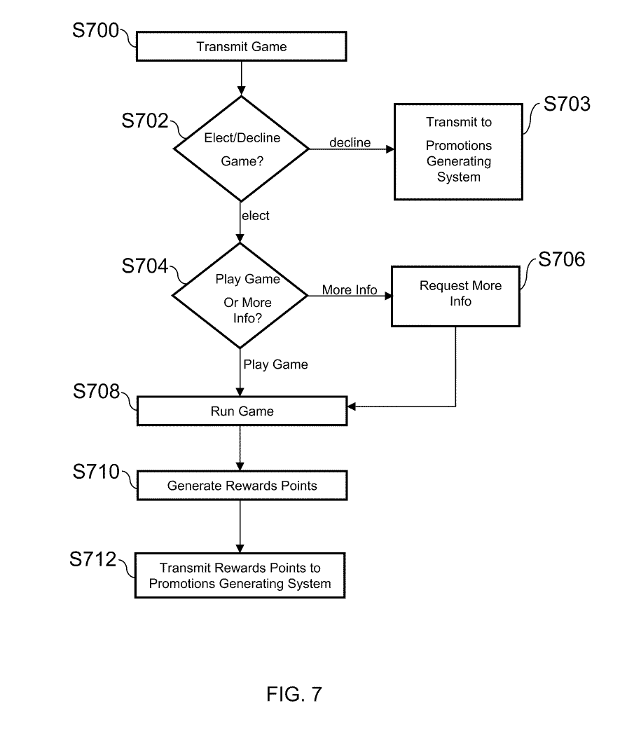

Referring to FIG. 7, in exemplary embodiments, mobile electronic device 102 can receive a transmission indicating that a game is available to be used on mobile electronic device 102 and promotions can be generated based on, for example, usage of the game. For example, at step 700, a transmission from promotions generating system 104 can be received by mobile electronic device 102 and a prompt can be generated on mobile electronic device 102 indicating a game is available for use.

At step 702, a user can elect or decline to receive and/or play the game. If not elected, information can be transmitted from mobile electronic device 102 to promotions generating system 104, at step 703, for example, to compile a list of non-elected games sent to mobile electronic device 102 that can be stored in user/device database 134. If elected, a prompt can be generated indicating that the user can elect to play the game or receive more information (e.g., the rules of the game, the promotion rules, etc.), at step 704. If the user requests more information then more information can be provided, at step 706. After receiving the more information the user can then continue to step 708, to begin playing the game. If the user requests to play the game, at step 704, they can begin playing the game, at step 708. At step 710, the user receives reward points (e.g., rewards data). These reward points can then be transmitted to promotions generating system 104 to generate rewards, step 712.

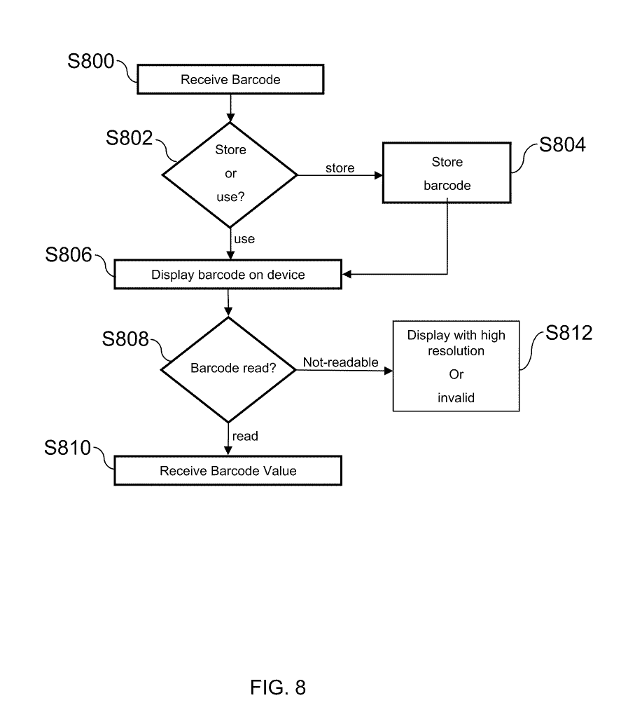

Referring to FIG. 8, in exemplary embodiments, promotion alerts and/or promotions can include a barcode that can be can be generated on mobile electronic device 102. For example, based on any of the techniques disclosed herein for receiving promotion alerts and/or promotions, a user can receive a barcode for display on the graphical user interface 108 of mobile electronic device 102, at step 800. At step 802, the user can elect to store the electronic barcode for later use or immediate use. If stored, the barcode can be stored in processor readable memory 114 of mobile electronic device 102, at step 804. If elected for immediate use, or a retrieved previously stored barcode, the barcode can be displayed on the graphical user interface 108, at step 806. The barcode can then be displayed in the vicinity of a barcode reader, at step 808. If the barcode is read, the user can receive the value associated with the barcode, at step 810. For example, the user can receive any one of, but not limited to, a discount on the purchase of a product, a discount on a purchase, a cash amount, or any other value which can be associated with a barcode. If the barcode is not read, the barcode can be refreshed and displayed with higher resolution or removed as invalid, at step 812.

In exemplary embodiments, at any point before receiving or using the barcode or after receiving or using the barcode the user can receive an option to obtain promotion alerts and/or promotions in exchange for changing the audible alert on mobile electronic device 102. Similarly described above, rewards data and/or promotion alerts and/or promotions can be generated by accepting to change the audible alert of the mobile electronic device to a predetermined audible alert and rewards data can be generated based on the duration of use of the changed audible alert. In exemplary embodiments, rewards data can be based on barcode usage (e.g., to incentivize the user to redeem the barcode), and the number of barcodes the user has stored, to name a few.

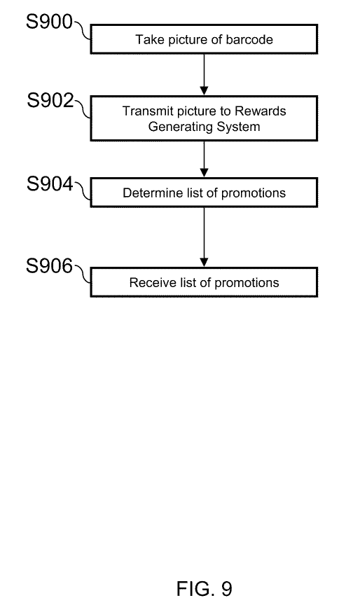

Referring to FIG. 9, in exemplary embodiments, promotions can be transmitted to mobile electronic device 102 in response to a barcode image transmitted from mobile electronic device 102 to promotions generating system 104. For example, a user can take a picture of a barcode on a product, at step 900 and the image can then be transmitted to promotions generating system 104 from the mobile electronic device 102, at step 902. Promotions generating system 104 can then determine the information related to the barcode, review a list of advertisers in processor readable memory 122 having promotions related to that barcode, and populate a list of promotions relevant to the barcode, at step 904. At step 906, the user can receive promotions relating to the barcode.

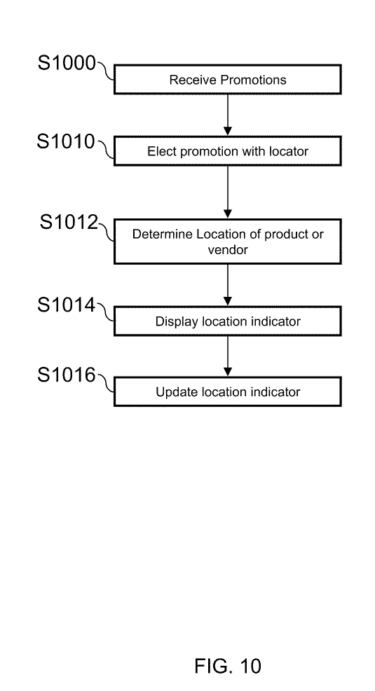

Referring to FIG. 10, in exemplary embodiments, promotion alerts and/or promotions can include a locator option that can help a user locate a product or vendor affiliated with the promotion. For example, a user can have an advertisement (e.g., a promotion list, an individual offer, etc) transmitted to mobile electronic device 102 from promotions generating system 104, at step 1000. The user can select a promotion having a locator, for example, populated in a promotion list or an individual promotion offer, at step 1010. At step 1012, promotions generating system 104 can determine the location of the product or vendor by, for example, accessing processor readable memory 122 or any other relevant database having product or store location data. For example, the location of a product or vendor can be determined based at least one of, but not limited to a geographic coordinate system (e.g., longitudinal and latitudinal, geodesic height, cartesian coordinates, etc.), Radio Frequency Identification (e.g., Long range RFID; Short range RFID; using active RFID tags, passive RFID tags, battery assisted passive RFID tags; etc.), or any other reasonable way to locate a product or vendor. Further, mobile electronic device 102 can display a location indicator to the user, for example, on the graphical user interface and/or produce an audible location indicator using speaker 110, at step 1014. The indicator can be, but is not limited to, a map with a route plotted, a directional arrow, a display (e.g., a display of the aisle number, product name, picture/banner, etc.), or any other reasonable indicator. For ease, both the audible indicator and indicator are described, at times, simply as a location indicator. At step 1016, the location indicator can auto update the user's location relative to a product and/or vendor using any reasonable technique, such as Global Positions Systems (GPS), network based triangulation, and WiFi™ server information, to name a few.

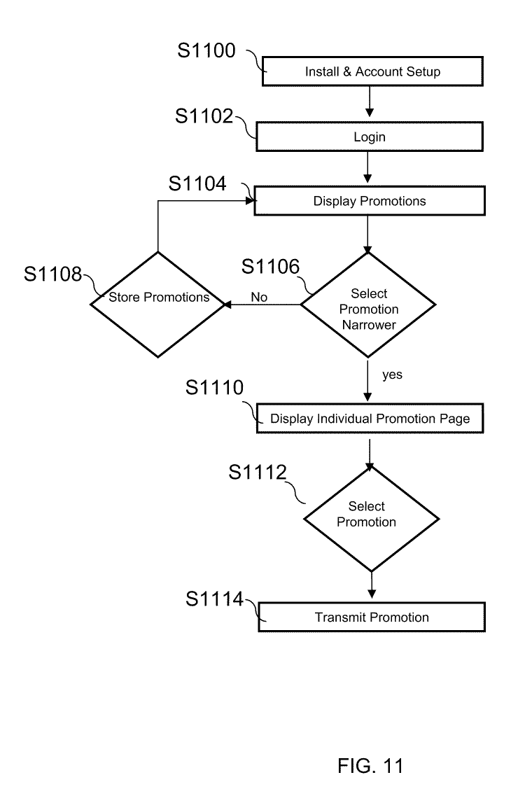

Referring to FIG. 11, in exemplary embodiments, promotion alerts and/or promotions can be transmitted to mobile electronic device 102 in response to a user installing and setting up an account with promotions generating system 104. For example, at step 1100 a user can download processor readable information that can be stored on processor readable memory 114 and processed by a processor 116 on mobile electronic device 102. In exemplary embodiments, a user can create an account that can be affiliated with a username and/or password or other identifying information by inputting information such as, but not limited to, name, email, and password, to name a few. Further, a user can input “favorites” and/or “preferences” from a list that can include, but is not limited to, brands, stores, and categories, to name a few.

In exemplary embodiments, promotion alerts and/or promotions can be transmitted to mobile electronic device 102 based on user input “favorites” and/or “preferences.” For example, at step 1102, after an account has been setup the user can actively select to login and/or automatically login to their account and receive promotion alerts and/or promotions at mobile electronic device 102 from promotions generating system 104. In some instances, the user name and password can be automatically input from the account creation process and/or a user can select to save their username and password such that the login is automatic. At step 1104, once logged in a main/home screen can be generated displaying available promotion alerts and/or promotions.

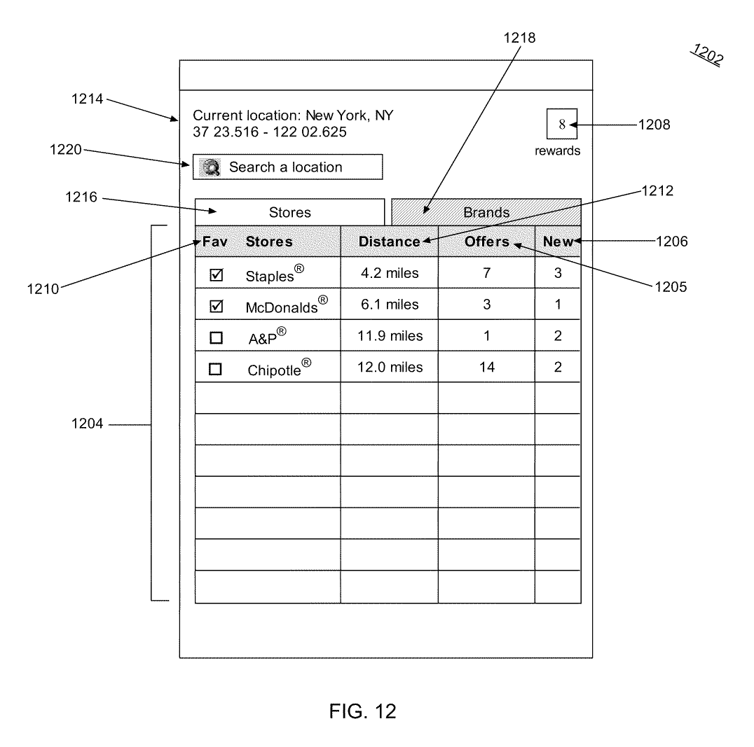

Referring to FIG. 12, in exemplary embodiments, main/home screen 1202 generated on mobile electronic device 102 can include, but is not limited to, a list of advertisers 1204, a list of promotions per advertiser 1205, new promotions 1206 per advertiser, a queue 1208 representing the total number of new promotions, a list of stores 1210 having promotions, a list of brands (not shown) having promotions, distance information 1212, and user location information 1214, to name a few.

In exemplary embodiments, multiple promotions can be displayed on main/home screen 1202 based on “favorites” and/or “preferences.” For example, while setting up an account a user can select from a list stores and/or brands that they wish to receive promotions from. As a further example, if a user did not input “favorites” and/or “preferences” during, for example, account setup then a limited number and/or no promotions may be presented on main/home screen 1202 because a user has not opted in to receive any promotions.

In exemplary embodiments, a user can input proximity information such that they only receive promotion alerts and/or promotions that are within a given distance from mobile electronic device 102 using any reasonable technique, such as Global Positions Systems (GPS), network based triangulation, and WiFi™ server information, to name a few.

Promotions can be grouped on main/home screen 1202 by, for example, stores, brands, categories, and/or by any other reasonable grouping technique. Further, a user can have the ability to view promotions grouped on main/home screen 1202 by for example, selecting a stores tab 1216 to view promotions grouped by stores and/or selecting a brands tab 1218 to view promotions grouped by brand.

Promotions grouped by store can display user location information 1214, the distance from the store to the user 1212, a list of stores 1210 available with the number of promotions 1204, a list of stores 1210 available with the number of new promotions 1206 and a queue 1208 representing the total number of new promotions, to name a few. For example, as shown, based on user input “favorites” and/or “preferences” main/home screen 1202 displays a list of stores 1210 (e.g., Staples®, McDonalds®, A&P®, Chipotle®, etc.), distance 1212 from the user to the store (e.g., 4.2 miles, 6.1 miles, 11.9 miles, 12.0 miles, etc.), promotions 1204 at each store (e.g., 7, 3, 1, 14, etc.), new promotions 1206 at each store (e.g., 3, 1, 2, 2), and a total number of new promotions 1208 (e.g., 8, etc.). Promotions grouped by brands (not shown) can include similar information listed by locations carrying specific brands.

In exemplary embodiments, a user can manually enter a location by, for example, selecting search a location 1220 and inputting information location and/or a user can sort and/or filter groupings by, for example, distance, alphabetically, and number of promotions, to name a few.

Referring back to FIG. 11, at step 1106 a user can select to see available offer(s) grouped by a specific location(s), grouped by a specific brand(s), or promotions grouped together by any other reasonable technique. If a user does not select to see available offer(s), the promotions can be stored for later access, at step 1108. For example, a user can at a later time return to main/home page 1202 and see stored promotions that are still available and/or new promotions. If a user does select to see available offer(s) narrowed by a grouping, then, at step 1110, promotions can be displayed individually to a user.

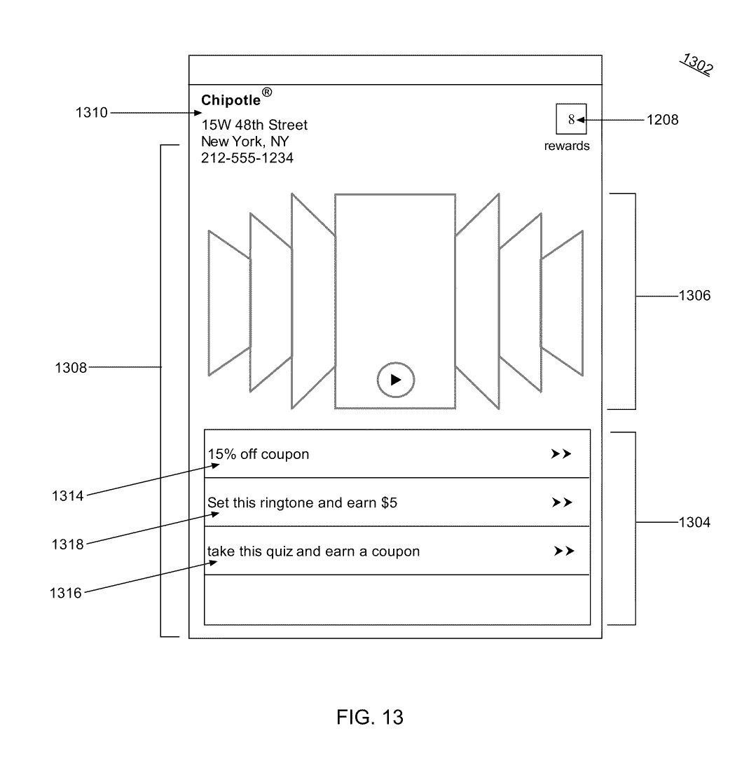

For example, referring to FIG. 13, in exemplary embodiments, promotions can be displayed individually to a user in an individual promotion viewer 1302 by an reasonable technique such as, but not limited to, a list/grid view 1304, a cover flow view 1306, a combination of grid view and cover flow view 1308, or by any other reasonable technique for displaying promotions. Further, individual promotion viewer 1302 can include location information 1310 and the total number of promotions queue 1208. Promotions queue 1208 can display the total number of new promotions available, the total number of new promotions only at a grouping, or any other reasonable numerical listing of promotions.

Individual promotion viewer 1302 can display promotions grouped by a specific store, promotions grouped by a brand, or promotions grouped by any other reasonable categorization. Promotions grouped by a store can show a list of promotions available at a store selected. Promotions grouped by brand can show a list of promotions available from stores within a predetermined distance carrying a selected brand.

In exemplary embodiments, promotions displayed in promotion viewer 1302 can include, but are not limited to, a direct/coupon based promotion 1314, a quiz based promotion 1316, and a ringtone based promotion 1318, to name a few. A direct/coupon based promotion 1314 can be, but is not limited to, a coupon that the user can use as a discount. A quiz based promotion 1316 can include any reasonable quiz such as, but not limited to, a multiple choice questions where promotions can be based on, for example, the number of correct answers. A ringtone based promotion 1318 can include, but is not limited to, an opportunity to set a ringtone in exchange for promotions. The ringtone reward data can be based on the number of times the ringtone is played on mobile electronic device 102.

Further, in exemplary embodiments, promotions can include, but are not limited to, a percentage off, a dollar amount off, and a free item redeemable in a store and/or mailed to a location, to name a few.

Referring back to FIG. 11, a user can select an offer, at step 1112, and have the promotion transmitted to mobile electronic device 102, at step 1114, and or mailed to a location. The location can be input during step 1100 and/or can be input at a later time by filling out a mailing address form.

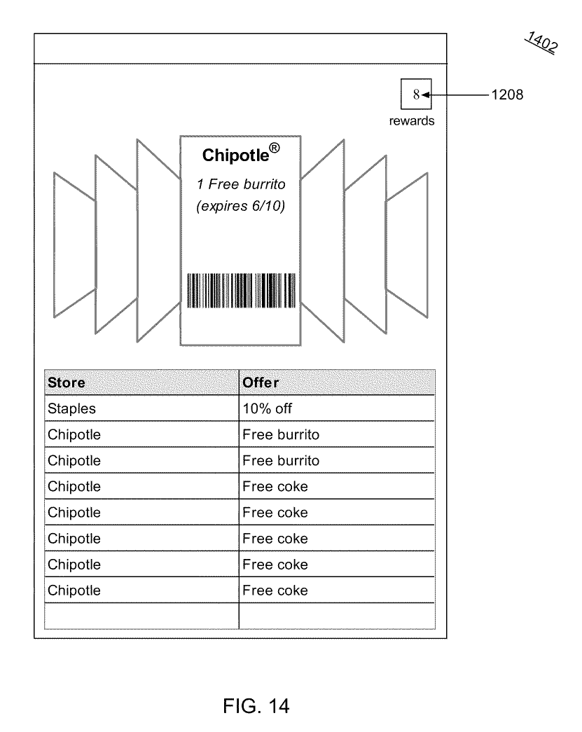

Referring to FIG. 14, in exemplary embodiments, all promotions in reward queue 1208 can be displayed to a user in a promotion viewer 1402 using any reasonable technique such as, but not limited to, a list/grid view, a cover flow view, a combination of grid view and cover flow view, or by any other reasonable technique for displaying promotions. Further, reward queue 1208 can remain displayed in graphical user interface 108 of mobile electronic device 102, for example, depicting the numerical value of available promotions.

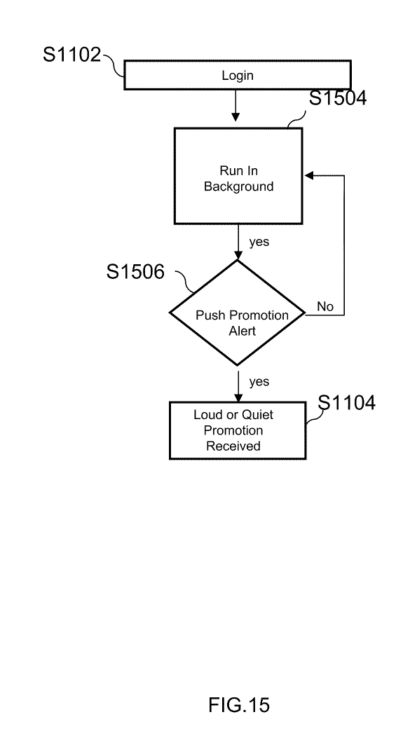

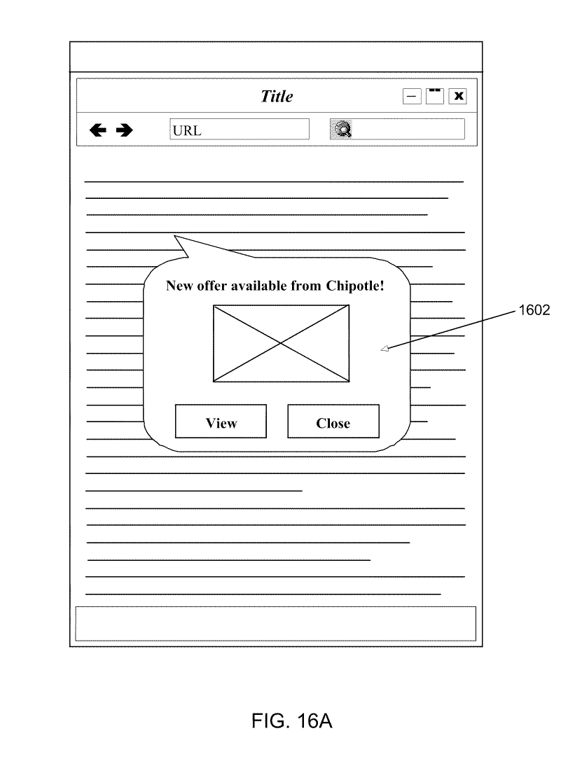

Referring to FIG. 15, in exemplary embodiments, after logging in, at step 1102, the application can run in the background, at step 1504 of mobile electronic device 102 and promotion alerts can be transmitted (e.g., pushed), at step 1506, to mobile electronic device 102 based on user “favorites” and/or “preferences” and/or user location. The promotion alerts can include a promotions and/or a reminder of promotions that are in rewards queue 1208 (not shown). In exemplary embodiments, a promotion alert can be actively and/or passively pushed. A promotion alert that is actively pushed can alert a user by, for example, generating a jingle, activating a vibrational alert and/or displaying a message on graphical user interface 108 of mobile electronic device 102. A promotion alert that is passively pushed can update the numerical digit in queue 1208 displayed, for example, as an icon on mobile electronic device 102 and/or can silently display a message on mobile electronic device 102. Further, queue 1208 can update each time a user opens the application.

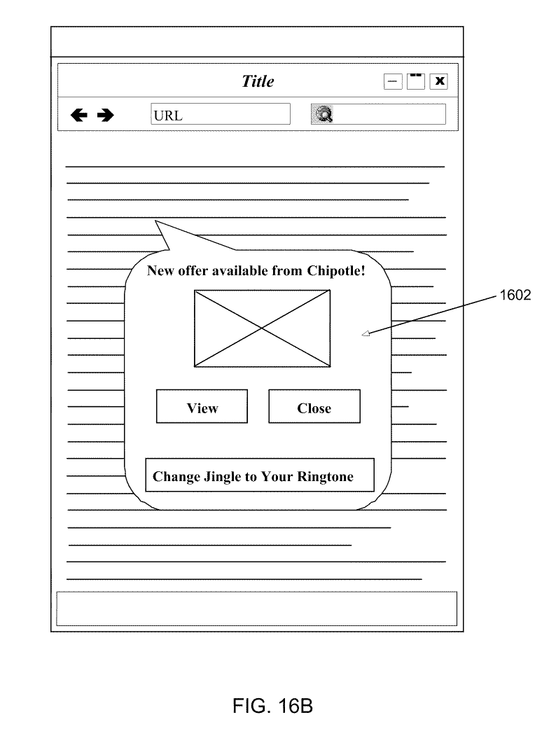

For example, referring to FIG. 16A, a push promotion alert 1602 can be displayed on mobile electronic device 102 and may require a user to view or close promotion alert 1602. As a further example, referring to FIG. 16B, a push promotion alert 1062 can be displayed on mobile electronic device 102 and a user can also have the option to change their mobile electronic device's alert to, for example, a jingle that may be associated with the push promotion alert.

In exemplary embodiments, an administrator and/or a campaign manager can access promotions generating system 104 and/or information based at least in part on data from promotions generating system 104 to oversee and/or manage individual user accounts and/or promotion provider accounts.

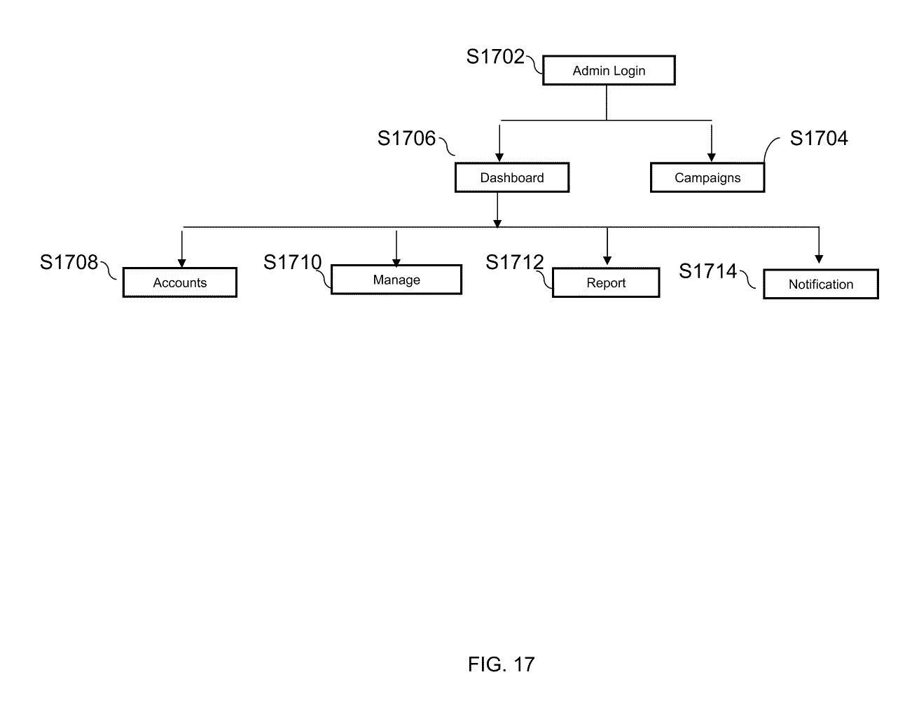

Referring to FIG. 17, at step 1702, an administrator can login to promotions generating system 104 and can view campaigns, at step 1704, and/or can access a dashboard, at step 1706, to manage and/or oversee any reasonable aspect of promotion generating system 104 such as, but not limited to, accessing accounts, at step 1708; managing information, at step 1710; creating reports, at step 1712; and generating notifications, at step 1714, to name a few.

At step 1708 and 1710, an administrator can access and/or manage user accounts and/or promotion provider accounts by, for example, accessing user information; accessing promotion provider information; accessing permissions; creating, editing, disabling, and/or deleting user accounts and/or promotion provider accounts; and transmitting information to a user and/or promotion provider by, for example, a tokenized email for creating an account within the system. Further an administrator can access and/or manage information relating to store locations, promotions, ringtones, quizzes, and rewards, to name a few. Even further, an administrator can assign read write permissions to accounts and may limit the number of promotions that can be created in a promotion provider account. Further, the administrator can approve and/or reject promotions for a promotion provider account and/or a user account.

At step 1712, an administrator accessing promotions generating system 104 can create reports on data, such as, but not limited to, user accounts, promotion provider accounts, promotions, or any other reasonable report. Reports can be formatted in any reasonable format, such as, but not limited to, comma separated variable and reports can be filterable. Reports can include any reasonable information relating to, for example, promotions, ringtones, quizzes, users, and fulfillment, to name a few.

Promotion information can include, but is not limited to, the number of promotions sent to a mobile device and/or mobile platform; the number of “viewed” and/or “ignored” promotions; promotions listed by popularity and/or usage; consumer category information, such as, but not limited to, age, gender, location, or any other reasonable consumer category information; and promotions reports based on location, to name a few.

Ringtones information can include, but is not limited to, the number of times a ringtone has been downloaded and/or installed; the number of times a ringtone was activated on a mobile electronic device; how loud the ringtone was on the mobile electronic device; and how long the ringtone was on the mobile electronic device; to name a few.

Quiz information can include, but is not limited to, the questions and/or answers to quiz questions; user data relating to the number of questions answered correct and/or incorrect; and user data relating to the number of people who answered each quiz, to name a few.

User information can include, but is not limited to, the client application download by phone and/or time; a user profile page; and search information indicating the location of the user, to name a few.

Fulfillment information can include, but is not limited to, whether or not a given number of promotions have been delivered and/or whether or not a promotion was used.

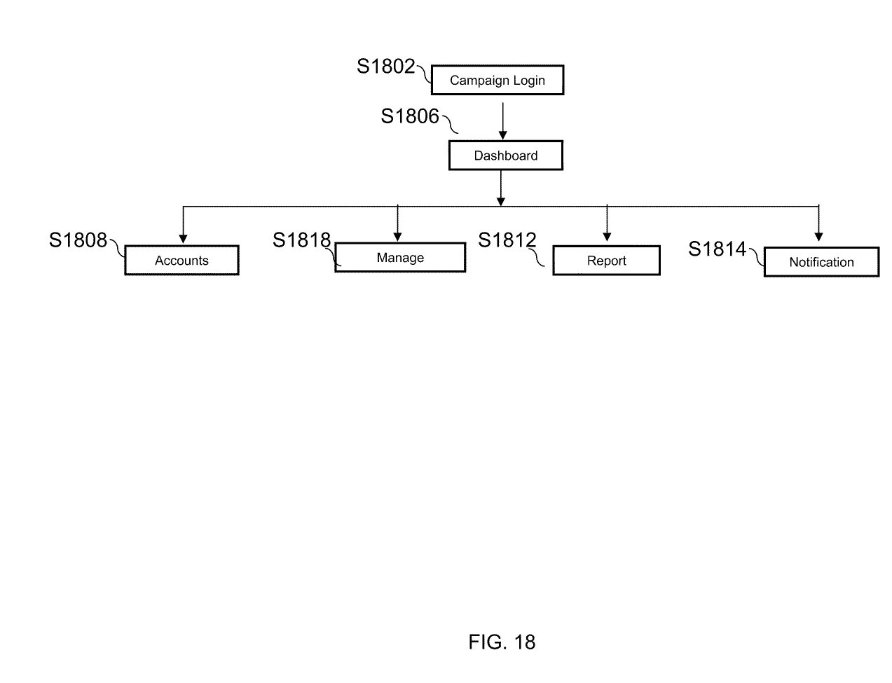

Referring to FIG. 18, at step 1802, a campaign manager can login to promotions generating system 104 and can view campaigns through a user interference; such as a dashboard, at step 1804 to manage and/or oversee any reasonable aspect of promotion generating system 104 such as, but not limited to, accessing accounts, at step 1808; managing information, at step 1810; creating reports, at step 1812; and generating notifications, at step 1814, to name a few.

At step 1808 and 1810, a campaign manager can access and/or manage user accounts by, for example, accessing user information; accessing permissions; creating; editing, disabling, and/or deleting user accounts; and transmitting information to a user by, for example, a tokenized email for creating an account within the system. Further a campaign manager can access and/or manage information relating to store locations, promotions, ringtones, quizzes, and rewards, to name a few.

Further, a campaign manager can, for example, create, edit, and delete store locations and can create and deploy promotions which can include, but are not limited to, a promotion type, a task related to a geographic area for a promotion; a promotion publication date; and group segmentation information such as, but not limited to, age, sex, location, to name a few. Further, a campaign manager can create, edit, and delete promotions input item identification information, such as, but not limited to a Universal Product Code number; generate optical machine-readable data such as, but not limited to, a barcode; define a percentage off; define a dollar amount off; and define a free item located at a store or sent to a location, to name a few. Further, a campaign manager can upload files, preview files, and name files and can manage quizzes using, for example, conditional branching, and inputting custom graphics and text descriptions.

At step 1812, a campaign manager accessing promotions generating system 104 can create reports on data, such as, but not limited to, user accounts, promotions, or any other reasonable report. Reports can be formatted in any reasonable format, such as, but not limited to, comma separated variable and reports can be filterable. Reports can include any reasonable information relating to, for example, promotions, ringtones, quizzes, users, and fulfillment, to name a few.

Promotion information can include, but is not limited to, the number of promotions sent to a mobile device and/or mobile platform; the number of “viewed” and/or “ignored” promotions; promotions listed by popularity and/or usage; consumer category information, such as, but not limited to, age, gender, location, or any other reasonable consumer category information; and promotions reports based on location, to name a few.

Ringtones information can include, but is not limited to, the number of times a ringtone has been downloaded and/or installed; the number of times a ringtone was activated on a mobile electronic device; how loud the ringtone was on the mobile electronic device; and how long the ringtone was on the mobile electronic device, to name a few.

Quiz information can include, but is not limited to, the questions and/or answers to quiz questions; user and/or rewards data relating to the number of questions answered correct and/or incorrect; and user and/or rewards data relating to the number of people who answered each quiz, to name a few.

User information can include, but is not limited to, the client application downloaded by phone and/or time; a user profile page; and search information indicating the location of the user, to name a few.

Fulfillment information can include, but is not limited to, whether or not a given number of promotions have been delivered and/or whether or not a promotion was used.

It will be understood that a user of a mobile electronic device can access promotions generating system to view and modify user information. User information can be based on any reasonable information such as preferences and favorites, rewards data, promotions information, promotion alerts information, and any other reasonable form of information.

Now that exemplary embodiments of the present invention have been shown and described in detail, various modifications and improvements thereon will become readily apparent to those skilled in the art. Accordingly, the spirit and scope of the present invention is to be construed broadly.

What is claimed is:

1. A method for transmitting promotions to a mobile electronic device, comprising:
providing a promotions system capable of:
storing, in at least one processor readable memory, (i) a plurality of store location data, (ii) promotions (iii) a plurality of promotions data affiliating a store location with at least one of a promotion for the store and a promotion for a brand at the store, (iv) promotions parameters data associated with advertiser preferences for promotions data, (v) user data, and (vi) user preferences data including a list of user preferred stores and brands;
receiving, using at least one communications portal, user location data and;
analyzing, using at least one processor, the user location data and (i) the plurality of store location data, (iii) the a plurality of promotion data, (iv) the promotions parameters data, (v) the user data, and (vi) the user preferences data such that a plurality of stores within a predefined distances from a user that are offering promotions and that are at least one of user preferred stores and stores selling user preferred brands are identified;
transmitting, using the at least one communication portal, a plurality of promotions to the mobile electronic device for a plurality of stores identified as having promotions that are within a predetermined distance from the user and that are at least one of user preferred and sell user preferred brands; and
receiving redemption information, using the at least one communication portal.

2. The method of claim 1, wherein the redemption information is stored in the processor readable memory and processed by the at least one processor to generate reports.

3. The method of claim 2, wherein the generated report is further comprising at least one of fulfillment data, promotions information, and user information.

4. The method of claim 2, wherein the generated report is further comprising fulfillment data.

5. The method of claim 1, wherein the redemption information is further comprising rewards data, stored in the processor readable memory, and is processed by the processor to generate additional rewards.

6. The method of claim 1, wherein the promotions parameter data is uploaded, via a communication portal, by at least one of a campaign manager and administrator.

7. The method of claim 1, wherein the transmitted promotions are further comprising at least one of a coupon, a discount, a barcode, and a free item.

8. The method of claim 7, wherein the generated report is further comprising at least one of fulfillment data, user information, ringtone information, quiz information, barcode information, and free item information.

9. The method of claim 1, further comprising:
transmitting, using at least one communication portal, a promotions program capable of being installed on the mobile electronic device and capable of displaying promotions on the mobile electronic device.

10. The method of claim 9, wherein the promotions are displayed in a list depicting a store name, the distance the user is from the store, and the number of promotions at the store.

11. The method of claim 10, wherein a user can select a store having multiple promotions and view a plurality of promotions depicted in at least one of a list view, cover flow view, and combination of list view and cover flow view.

12. The method of claim 10, wherein the promotions program determines when new promotions are made available since the user has last viewed the list of promotions and depicts the number of new promotions.

13. The method of claim 1, wherein the promotions include at least one of a coupon, a quiz, and an offer to change the alert notification of the mobile electronic device.

14. The method of claim 13, wherein the generated report includes information about at least one of the quantity of use, duration of use, and volume during use of the alert notification.

15. The method of claim 13, further comprising:
generating rewards data when at least one of the quiz is run on the mobile electronic device and the alert notification of the mobile electronic device is changed;
receiving the rewards data at the promotions system; and
transmitting additional promotions based on the rewards data.

16. A system for accessing and managing promotions transmitted to a mobile electronic device, comprising:
a promotions system comprising:
at least one processor readable memory for storing in at least one database (i) a plurality of store location data, (ii) promotions, (iii) a plurality of promotions data affiliating a store location with at least one of a promotion for the store and a promotion for a brand at the store, (iv) promotions parameters data associated with advertiser preferences for promotions data, (v) user data, (vi) user preferences data including a list of user preferred stores and brands, (vii) redemptions data;
at least one processor for accessing each of (i) the plurality of store location data, (ii) promotions (iii) the a plurality of promotion data, (iv) the promotions parameters data, (v) the user data, (vi) the user preferences data, and (vii) redemption data to generate at least one report;
at least one communication portal for communicating the generated reports based on (i) the plurality of store location data, (ii) the a plurality of promotion data, (iv) the promotions parameters data, (v) the user data, (vi) the user preferences data, and (vii) redemption data; and
wherein a user can access the promotions system via a web portal and manage promotions to be transmitted to a mobile electronic device.

17. The system of claim 16, wherein the user is an administrator and the administrator can access, via the communication portal, the promotions system and create accounts for users, stored in processor readable memory.

18. The system of claim 16, wherein the reports are transmitted, via the communications portal, in comma separated variable format to the accessing system.

19. The system of claim 16, wherein the promotions transmitted, via the communications portal, to a mobile electronic device include at least one of discounts, ringtones, and quizzes.

20. The system of claim 19, wherein the user can upload, via a communications portal, the quizzes and ringtones to the promotions system and the quizzes and ringtones are stored in the processor readable memory.

21. The method of claim 19, wherein the generated report includes information about at least one of the quantity of use, duration of use, and volume during use of the alert notification.

22. The system of claim 19, wherein the promotion can include a machine readable code.

23. The system of claim 19, wherein the user can generate quizzes on the promotions system by inputting data into predefined field.
